(19) United States
(12) Patent Application Publication
(10) Pub. No.: US 2026/0245542 A1
(43) Pub. Date: Aug. 20, 2026

(54) REAL-TIME AND EMOTION-AWARE SPEECH SYNTHESIS SYSTEM AND ASSOCIATED METHOD

(71) Applicant: Realtek Semiconductor Corp., HsinChu (TW)

(72) Inventor: Hung-Ying Chen, HsinChu (TW)

(73) Assignee: Realtek Semiconductor Corp., HsinChu (TW)

(21) Appl. No.: 19/426,023

(22) Filed: Dec. 18, 2025

(30) Foreign Application Priority Data
Feb. 18, 2025 (TW) 114105838

(51) Int. Cl. G10L 13/047; G10L 13/027; G10L 25/63; G10L 25/93

(52) U.S. Cl. CPC G10L 13/047; G10L 13/027; G10L 25/63; G10L 25/93

(57) ABSTRACT

A speech synthesis system includes multiple modules/models. A vocal voice channel isolation module performs an isolation operation upon an audio input signal to generate multiple vocal voice channels and a single non-vocal voice channel. An automatic speech recognition (ASR) module selects a target vocal voice channel from the multiple vocal voice channels according to a source language text. A speech emotional recognition model performs a prediction operation upon each of the multiple vocal voice channels in order to generate a prediction result indicating a corresponding emotional classification. A feature adaptive text-to-speech (TTS) system performs a speech synthesis operation according to the source language text, a target language text, the target vocal voice channel, and the emotional classification, to generate a synthetic vocal voice. An audio multi-channel mixing module performs a mixing operation upon the single non-vocal voice channel and the synthetic vocal voice to generate an audio output signal.

### BACKGROUND OF THE INVENTION

### 1. Field of the Invention

The present invention is related to speech synthesis, and more particularly, to a real-time and emotion-aware speech synthesis system and an associated method.

### 2. Description of the Prior Art

In an existing speech synthesis system (e.g., a dubbing system), appropriate speech segments may be selected from a speech database and concatenated to rapidly generate synthesized speech. This system, however, has poor flexibility when dealing with unexpected text or rare vocabulary. The fluency and naturalness of the voice may be constrained, and consistency in emotional recognition and emotional expression in speech cannot be maintained, particularly in cross-lingual application scenarios.

In another existing speech synthesis system, a deep learning model can be trained by using large amounts of annotated speech data and annotated text data, and the speech synthesis can be performed by using the trained deep learning model. This system, however, often requires a large number of model parameters to adapt to different application scenarios, which significantly reduces the computational efficiency.

In addition, the above-mentioned speech synthesis systems can only fine-tune parameters during the training phase based on a timbre characteristic of the target speech (e.g., a breathing habit and articulation), which may lead to issues in high-fidelity speech synthesis. Moreover, due to the high computational and memory requirements of the deep learning model, the existing speech synthesis system systems typically rely on large data centers or cloud services for processing, which introduces latency, high computational costs, and privacy concerns.

As a result, a novel speech synthesis system capable of operating on an edge device and generating fluent, natural, and emotionally expressive speech based on different application scenarios is urgently needed in the field.

### SUMMARY OF THE INVENTION

It is therefore one of the objectives of the present invention to provide a real-time and emotion-aware speech synthesis system and an associated method, in order to address the above-mentioned issues.

According to an embodiment of the present invention, an electronic device is provided, wherein the electronic device comprises a storage device and a processor. The storage device is arranged to store a program code. The processor is arranged to load and execute the program code, wherein the program code instructs the processor to execute a speech synthesis system. The speech synthesis system comprises a vocal voice channel isolation module, an automatic speech recognition (ASR) module, a speech emotional recognition model, a feature adaptive text-to-speech (TTS) system, and an audio multi-channel mixing module. The vocal voice channel isolation module is arranged to perform an isolation operation upon an audio input signal in order to generate multiple vocal voice channels and a single non-vocal voice channel. The ASR module is arranged to select a target vocal voice channel from the multiple vocal voice channels according to a source language text. The speech emotional recognition model is arranged to perform a prediction operation upon each of the multiple vocal voice channels in order to generate a prediction result, wherein the prediction result indicates an emotional classification. The feature adaptive TTS system is arranged to perform a speech synthesis operation according to the source language text, a target language text, the target vocal voice channel, and the emotional classification in order to generate a synthetic vocal voice. The audio multi-channel mixing module is arranged to perform a mixing operation upon the single non-vocal voice channel and the synthetic vocal voice in order to generate an audio output signal.

According to an embodiment of the present invention, a method for performing speech synthesis is provided. The method comprises: performing an isolation operation upon an audio input signal in order to generate multiple vocal voice channels and a single non-vocal voice channel; selecting a target vocal voice channel from the multiple vocal voice channels according to a source language text; performing a prediction operation upon each of the multiple vocal voice channels in order to generate a prediction result, wherein the prediction result indicates an emotional classification; performing a speech synthesis operation according to the source language text, a target language text, the target vocal voice channel, and the emotional classification in order to generate a synthetic vocal voice; and performing a mixing operation upon the single non-vocal voice channel and the synthetic vocal voice in order to generate an audio output signal.

One of the benefits of the present invention is that the proposed speech synthesis system can extract a feature vector indicating a timbre characteristic from a target vocal voice, and perform a speech synthesis operation according to the feature vector, which can enable a generated synthetic vocal voice to adaptively match the timbre characteristic of the target vocal voice. In addition, the proposed speech synthesis system can automatically recognize and adapt to the emotional requirements of the current scenario by selecting an appropriate speech synthesis model from multiple candidate speech synthesis models, which can improve the accuracy of emotional recognition and ensure consistency and authenticity in emotional expression during speech synthesis. Additionally, the proposed speech synthesis system is capable of operating on a resource-constrained edge device, which can significantly reduce latency, lower computational costs, and enhance privacy and security.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a speech synthesis system according to an embodiment of the present invention.

FIG. 3 is a diagram illustrating a feature adaptive TTS system according to an embodiment of the present invention.

FIG. 4 is a flow chart of a method for speech synthesis according to an embodiment of the present invention.

### DETAILED DESCRIPTION

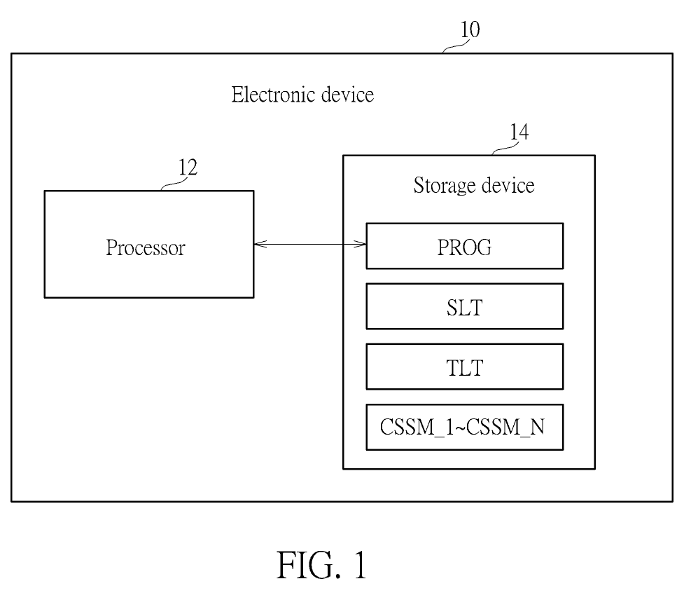

FIG. 1 is a diagram illustrating an electronic device 10 according to an embodiment of the present invention. Examples of the electronic device 10 may be, but are not limited to: a multi-functional mobile phone, a tablet, a portable device, and a personal computer (e.g., a desktop computer or a laptop). The electronic device 10 may include a processor 12 and a storage device 14 (e.g., a memory). The processor 12 may be a single-core processor or a multi-core processor. The storage device 14 may be arranged to store a program code PROG, a source language text SLT, a target language text TLT, and multiple candidate speech synthesis models CSSM_1 – CSSM_N, wherein “N” may be a positive integer greater than one. The processor 12 is equipped with software execution capability. When loaded and executed by the processor 12, the program code PROG instructs the processor 12 to execute a speech synthesis system proposed by the present invention. The electronic device 10 may be regarded as a computer system using a computer program product that includes a computer-readable medium containing the computer program code PROG. That is, the speech synthesis system proposed by the present invention can be embodied on the electronic device 10.

For example, under a situation where a player plays a video with an original speech in a first language, and the speech synthesis system is preset with a first language subtitle text corresponding to the original speech (i.e., the source language text, SLT) and a translated second language subtitle text (i.e., the target language text, TLT), the speech synthesis system may generate a corresponding target speech according to the original speech, the first language subtitle text, and the second language subtitle text, wherein the target speech can simulate a timbre characteristic (e.g., a breathing habit and an articulation) and a related emotion of the original speech, which provides higher-fidelity speech synthesis and ensures consistency and authenticity in emotional expression between the original speech and the target speech.

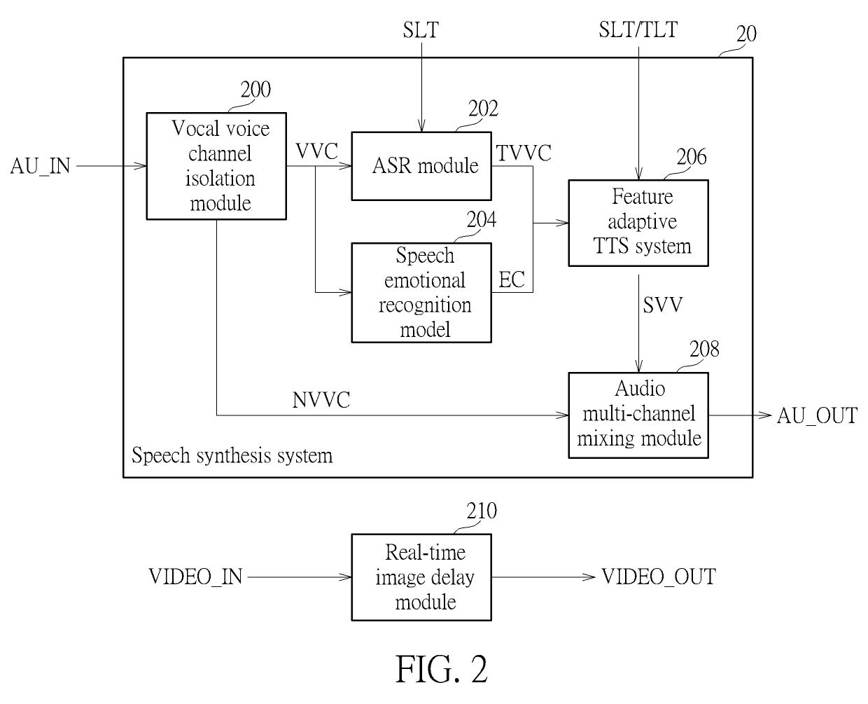

FIG. 2 is a diagram illustrating a speech synthesis system 20 according to an embodiment of the present invention, wherein the speech synthesis system 20 may be a real-time dubbing system based on artificial intelligence (AI), and may include multiple models/modules implemented by executing the program code PROG through the processor 12. The source language text SLT, the target language text TLT, and an audio input signal AU_IN may be input to the speech synthesis system 20, and the speech synthesis system 20 may perform speech synthesis upon the audio input signal AU_IN according to the source language text SLT and the target language text TLT in order to generate an audio output signal AU_OUT including a synthetic vocal voice SVV, wherein the audio input signal AU_IN corresponds to the source language text SLT, and the synthetic vocal voice SVV corresponds to the target language text TLT. As shown in FIG. 2, the speech synthesis system 20 includes a vocal voice channel isolation module 200, an automatic speech recognition (ASR) module 202, a speech emotional recognition model 204, a feature adaptive text-to-speech (TTS) system 206, and an audio multi-channel mixing module 208.

The vocal voice channel isolation module 200 may perform an isolation operation upon the audio input signal AU_IN in order to generate multiple vocal voice channels VVC and a single non-vocal voice channel NVVC (e.g., a background voice). For example, the vocal voice channel isolation module 200 may include a demixing model based on MDX-NET architecture and a speaker extraction model based on X-SepFormer architecture. The demixing model may isolate the audio input signal AU_IN into a single vocal voice channel and the single non-vocal voice channel NVVC. The speaker extraction model may isolate speech of multiple speakers within the single vocal voice channel into the vocal voice channels VVC, respectively.

The ASR module 202 may receive the vocal voice channels VVC and the source language text SLT, and select a target vocal voice channel TVVC from the vocal voice channels VVC according to the source language text SLT. The ASR module 202 may include an AI model (e.g., a Whisper model), wherein the vocal voice channels VVC (e.g., multiple audio signals carrying different vocal voices) may be input to the Whisper model, and the Whisper model may parse a text described by each of the vocal voice channels VVC in order to generate a parsed text for acting as an output of the Whisper model. The ASR module 202 may compare the parsed text with the source language text SLT in order to generate a comparison result COM_RT for selecting the target vocal voice channel TVVC, wherein the comparison result COM_RT indicates a similarity between the parsed text and the source language text SLT.

The speech emotional recognition model 204 may be an AI model (e.g., a model based on ECAPA-TDNN architecture), wherein the vocal voice channels VVC (e.g., multiple audio signals carrying different vocal voices) may be input to the model, and the model may perform a prediction operation upon each of the vocal voice channels VVC in order to generate a corresponding emotional classification EC for acting as an output of the model. In detail, the emotional classification EC may be further set during a training phase of the model. For example, an emotion of a speaker can be pre-categorized into happiness, anger, sorrow, and joy as the emotional classification EC. In another example, the emotional classification EC can be further divided into a male/female voice or a high-pitched/low-pitched voice, depending on design considerations. In other words, the types of the emotional classification EC can be predetermined during the training phase of the model, and the model can be trained based on the determined emotional classification EC in order to perform the emotional recognition operation.

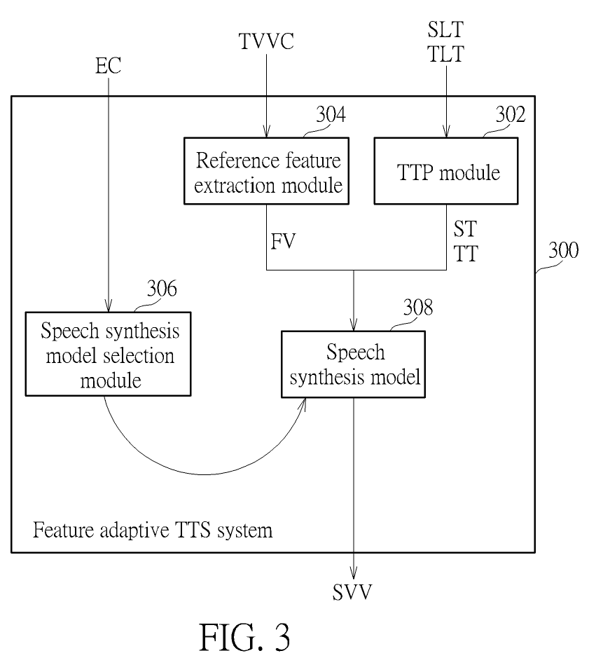

The feature adaptive TTS system 206 may receive the source language text SLT, the target language text TLT, the target vocal voice channel TVVC, and the emotional classification EC, and obtain the synthetic vocal voice SVV of the target language with a timbre characteristic of the audio input signal AU_IN according to the received inputs. Refer to FIG. 3, which is a diagram illustrating a feature adaptive TTS system 300 according to an embodiment of the present invention, wherein the feature adaptive TTS system 206 shown in FIG. 2 may be implemented by the feature adaptive TTS system 300. As shown in FIG. 3, the feature adaptive TTS system 300 may include a text-to-phoneme (TTP) module 302, a reference feature extraction module 304, and a speech synthesis model selection module 306.

The TTP module 302 may perform a tokenization operation upon the source language text SLT and the target language text TLT in order to generate a source phoneme ST and a target phoneme TT, and more particularly, may map the source language text SLT and the target language text TLT to the source phoneme ST and the target phoneme TT, respectively.

The reference feature extraction module 304 may be an AI model (e.g., a model based on HuBERT), and may perform an extraction operation upon the target vocal voice channel TVVC (e.g., an audio signal carrying the target vocal voice) in order to generate a feature vector FV, wherein the feature vector FV may indicate a timbre characteristic (e.g., a breathing habit and an articulation) of the target vocal voice channel TVVC (or the target vocal voice), and may be input to a subsequent speech synthesis model for achieving adaption of the timbre characteristic of the target vocal voice. For example, the reference feature extraction module 304 may regard the target vocal voice channel TVVC as a sequence, and perform a tokenization operation and a transformer-related computational operation upon the sequence in order to obtain the feature vector FV.

The speech synthesis model selection module 306 may select a speech synthesis model matching an emotion indicated by the emotional classification EC from the candidate speech synthesis models CSSM_1 – CSSM_N within the storage device 14 according to the emotional classification EC, for acting as a speech synthesis model 308. In this way, the emotion corresponding to the target vocal voice channel TVVC can be simulated, and the purpose of emotional perception and emotional expression can be achieved. In addition, under a situation where a trade-off between the model performance and the model efficiency is required, the speech synthesis model selection module 306 can be used to avoid the issue of a single model having to adapt to different usage scenarios (or different emotional classifications), which can reduce the model size and resource requirements, thereby enabling speech synthesis to be performed on a resource-constrained edge device.

The speech synthesis model 308 may generate the synthetic vocal voice SVV according to the feature vector FV, the source phoneme ST, and the target phoneme TT. Specifically, each of the candidate speech synthesis models CSSM_1 – CSSM_N (e.g., the speech synthesis model 308) may be composed of a first model based on transformer-decoder architecture and a second model based on VITS. The first model may generate an embedding vector with the timbre characteristic of the target vocal voice according to the source phoneme ST, the target phoneme TT, and the feature vector FV, wherein the target phoneme TT corresponds to the target phoneme TT. The second model may generate the synthetic vocal voice SVV with the timbre characteristic of the target vocal voice according to the embedding vector. In addition, a speed parameter of the speech synthesis model 308 can be set to control a speech speed of the synthetic vocal voice SVV, which can further control an overall duration of the synthetic vocal voice SVV.

Refer back to FIG. 2. After generating the single non-vocal voice channel NVVC and the synthetic vocal voice SVV by the vocal voice channel isolation module 200 and the feature adaptive TTS system 206, the audio multi-channel mixing module 208 may perform a mixing operation upon the single non-vocal voice channel NVVC and the synthetic vocal voice SVV to generate the audio output signal AU_OUT.

It should be noted that, when the program code PROG is loaded and executed by the processor 12, the program code PROG may further instruct the processor 12 to execute a real-time image delay module 210, wherein the real-time image delay module 210 may perform a delay operation upon an image input signal VIDEO_IN according to a system delay time of the speech synthesis system 20 in order to achieve the real-time dubbing function. Specifically, assume that an audiovisual signal includes the audio input signal AU_IN and an image input signal VIDEO_IN. When the audio input signal AU_IN is input to the speech synthesis system 20, the image input signal VIDEO_IN is simultaneously input to the real-time image delay module 210 in order to set the image input signal VIDEO_IN to be output as an image output signal VIDEO_OUT after a specific delay time (e.g., the system delay time of the speech synthesis system 20). In this way, the purpose of aligning the audio output signal AU_OUT with the image output signal VIDEO_OUT before outputting can be achieved.

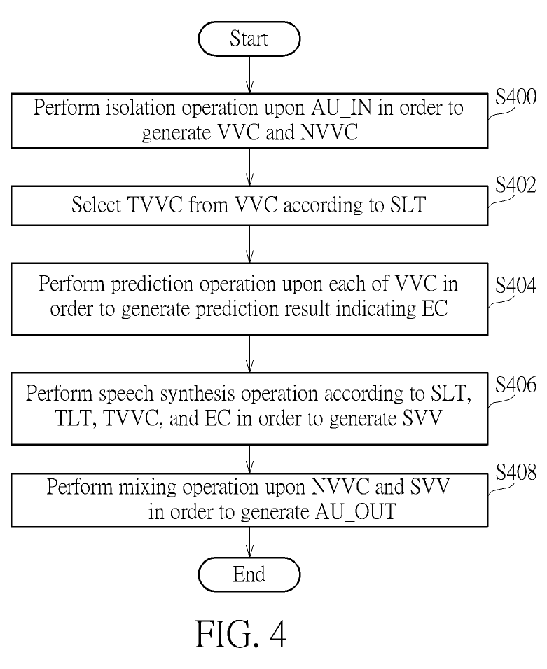

FIG. 4 is a flow chart of a method for speech synthesis according to an embodiment of the present invention. Provided that the result is substantially the same, the steps are not required to be executed in the exact order shown in FIG. 4. For example, the method shown in FIG. 4 may be employed by the speech synthesis system 20 (more particularly, the modules/models therein) shown in FIG. 2.

In Step S400, an isolation operation is performed upon the audio input signal AU_IN in order to generate the vocal voice channels VVC and the single non-vocal voice channel NVVC.

In Step S402, the target vocal voice channel TVVC is selected from the vocal voice channels VVC according to the source language text SLT.

In Step S404, a prediction operation is performed upon each of the vocal voice channels VVC in order to generate a prediction result, wherein the prediction result indicates the emotional classification EC of the vocal voice channel.

In Step S406, a speech synthesis operation is performed according to the source language text SLT, the target language text TLT, the target vocal voice channel TVVC, and the emotional classification EC in order to generate the synthetic vocal voice SVV.

In Step S408, a mixing operation is performed upon the single non-vocal voice channel NVVC and the synthetic vocal voice SVV in order to generate the audio output signal AU_OUT.

Since a person skilled in the pertinent art can readily understand details of the steps after reading the above paragraphs directed to the speech synthesis system 20 shown in FIG. 2, further descriptions are omitted here for brevity.

In summary, the proposed speech synthesis system can extract a feature vector indicating a timbre characteristic from a target vocal voice, and perform a speech synthesis operation according to the feature vector, which can enable a generated synthetic vocal voice to adaptively match the timbre characteristic of the target vocal voice. In addition, the proposed speech synthesis system can automatically recognize and adapt to the emotional requirements of the current scenario by selecting an appropriate speech synthesis model from multiple candidate speech synthesis models, which can improve the accuracy of emotional recognition and ensure consistency and authenticity in emotional expression during speech synthesis. Additionally, the proposed speech synthesis system is capable of operating on a resource-constrained edge device, which can significantly reduce latency, lower computational costs, and enhance privacy and security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a storage device, arranged to store a program code; and
a processor, arranged to load and execute the program code, wherein the program code instructs the processor to execute a speech synthesis system, the speech synthesis system comprising:
a vocal voice channel isolation module, arranged to perform an isolation operation upon an audio input signal in order to generate multiple vocal voice channels and a single non-vocal voice channel;
an automatic speech recognition (ASR) module, arranged to select a target vocal voice channel from the multiple vocal voice channels according to a source language text;
a speech emotional recognition model, arranged to perform a prediction operation upon each of the multiple vocal voice channels in order to generate a prediction result, wherein the prediction result indicates an emotional classification;
a feature adaptive text-to-speech (TTS) system, arranged to perform a speech synthesis operation according to the source language text, a target language text, the target vocal voice channel, and the emotional classification in order to generate a synthetic vocal voice; and
an audio multi-channel mixing module, arranged to perform a mixing operation upon the single non-vocal voice channel and the synthetic vocal voice in order to generate an audio output signal.

2. The electronic device of claim 1, wherein the vocal voice channel isolation module comprises:
a demixing model, arranged to isolate the audio input signal into a single vocal voice channel and the single non-vocal voice channel; and
a speaker isolation model, arranged to isolate the single vocal voice channel into the multiple vocal voice channels.

3. The electronic device of claim 1, wherein the ASR module is further arranged to:
parse a text described by each of the multiple vocal voice channels in order to generate a parsed text; and
compare the parsed text with the source language text in order to generate a comparison result for selecting the target vocal voice channel, wherein the comparison result indicates a similarity between the parsed text and the source language text.

4. The electronic device of claim 1, wherein the feature adaptive TTS system comprises:
a text-to-phoneme (TTP) module, arranged to perform a tokenization operation upon the source language text and the target language text, respectively, in order to generate a source phoneme and a target phoneme.

5. The electronic device of claim 4, wherein the TTP module maps the source language text and the target language text to the source phoneme and the target phoneme, respectively.

6. The electronic device of claim 4, wherein the feature adaptive TTS system further comprises:
a reference feature extraction module, arranged to perform an extraction operation upon the target vocal voice channel in order to generate a feature vector, wherein the feature vector indicates a timbre characteristic of the target vocal voice channel.

7. The electronic device of claim 6, wherein the storage device further stores multiple candidate speech synthesis models, and the feature adaptive TTS system further comprises:
a speech synthesis selection module, arranged to perform a selection operation upon the multiple candidate speech synthesis models according to the emotional classification in order to generate a selected speech synthesis model.

8. The electronic device of claim 7, wherein the selected speech synthesis model performs the speech synthesis operation according to the feature vector, the source phoneme, and the target phoneme in order to generate the synthetic vocal voice; and the synthetic vocal voice has the timbre characteristic.

9. The electronic device of claim 8, wherein the selected speech synthesis model is further arranged to:
generate an embedding vector according to the source phoneme and the target phoneme; and
generate the synthetic vocal voice according to the embedding vector.

10. The electronic device of claim 9, wherein a speed parameter of the selected speech synthesis model is set to control a speech speed of the synthetic vocal voice.

11. A method for performing speech synthesis, comprising:
performing an isolation operation upon an audio input signal in order to generate multiple vocal voice channels and a single non-vocal voice channel;
selecting a target vocal voice channel from the multiple vocal voice channels according to a source language text;
performing a prediction operation upon each of the multiple vocal voice channels in order to generate a prediction result, wherein the prediction result indicates an emotional classification;
performing a speech synthesis operation according to the source language text, a target language text, the target vocal voice channel, and the emotional classification in order to generate a synthetic vocal voice; and
performing a mixing operation upon the single non-vocal voice channel and the synthetic vocal voice in order to generate an audio output signal.

12. The method of claim 11, wherein the step of performing the isolation operation upon the audio input signal in order to generate the multiple vocal voice channels and the single non-vocal voice channel comprises:
isolating the audio input signal into a single vocal voice channel and the single non-vocal voice channel; and
isolating the single vocal voice channel into the multiple vocal voice channels.

13. The method of claim 11, wherein the step of selecting the target vocal voice channel from the multiple vocal voice channels according to the source language text comprises:
parsing a text described by each of the multiple vocal voice channels in order to generate a parsed text; and
comparing the parsed text with the source language text in order to generate a comparison result for selecting the target vocal voice channel, wherein the comparison result indicates a similarity between the parsed text and the source language text.

14. The method of claim 11, wherein the step of performing the speech synthesis operation according to the source language text, the target language text, the target vocal voice channel, and the emotional classification in order to generate the synthetic vocal voice comprises:
performing a tokenization operation upon the source language text and the target language text, respectively, in order to generate a source phoneme and a target phoneme.

15. The method of claim 14, wherein the step of performing the tokenization operation upon the source language text and the target language text, respectively, in order to generate the source phoneme and the target phoneme comprises:
mapping the source language text and the target language text to the source phoneme and the target phoneme, respectively.

16. The method of claim 14, wherein the step of performing the speech synthesis operation according to the source language text, the target language text, the target vocal voice channel, and the emotional classification in order to generate the synthetic vocal voice comprises:
performing an extraction operation upon the target vocal voice channel in order to generate a feature vector, wherein the feature vector indicates a timbre characteristic of the target vocal voice channel.

17. The method of claim 16, wherein the step of performing the speech synthesis operation according to the source language text, the target language text, the target vocal voice channel, and the emotional classification in order to generate the synthetic vocal voice comprises:
performing a selection operation upon multiple candidate speech synthesis models according to the emotional classification in order to generate a selected speech synthesis model.

18. The method of claim 17, wherein the step of performing the speech synthesis operation according to the source language text, the target language text, the target vocal voice channel, and the emotional classification in order to generate the synthetic vocal voice comprises:
performing, by the selected speech synthesis model, the speech synthesis operation according to the feature vector, the source phoneme, and the target phoneme in order to generate the synthetic vocal voice, wherein the synthetic vocal voice has the timbre characteristic.

19. The method of claim 18, wherein the step of performing, by the selected speech synthesis model, the speech synthesis operation according to the feature vector, the source phoneme, and the target phoneme in order to generate the synthetic vocal voice further comprises:
generating, by the selected speech synthesis model, an embedding vector according to the source phoneme and the target phoneme; and
generating, by the selected speech synthesis model, the synthetic vocal voice according to the embedding vector.

20. The method of claim 19, further comprising:
setting a speed parameter of the selected speech synthesis model to control a speech speed of the synthetic vocal voice.
